(19) United States
(12) Patent Application Publication
(10) Pub. No.: US 2014/0138497 A1
(43) Pub. Date: May 22, 2014

(54) BRACKET DEVICE FOR INSTALLING AN ELECTRONIC DEVICE ON DIFFERENT OBJECTS

(71) Applicant: WISTRON NEWEB CORPORATION, Hsinchu (TW)

(72) Inventors: Bing-Chun Chung, Hsinchu (TW); Hung-Yuan Lin, Hsinchu (TW); Yun-Yi Ting, Hsinchu (TW)

(73) Assignee: WISTRON NEWEB CORPORATION, Hsinchu (TW)

(21) Appl. No.: 13/794,832

(22) Filed: Mar. 12, 2013

(30) Foreign Application Priority Data
Nov. 19, 2012 (TW) 101143095

(51) Int. Cl. F16M 13/02

(52) U.S. Cl. CPC F16M 13/02
USPC 248/73; 248/218.4; 248/219.4

(57) ABSTRACT

A bracket device for installing an electronic device on different objects is disclosed. The bracket device includes a bracket body, a supporting foot, a fixing member and a holding mechanism. The bracket body is for combining the electronic device. The supporting foot is connected to a side of the bracket body for supporting the bracket body and the electronic device. The fixing member is connected to another side of the bracket body. The fixing member includes at least one hanging structure for hanging the bracket body and the electronic device. The holding mechanism is installed on the fixing member in a detachable manner. The holding mechanism and the fixing member are cooperatively for holding a post, so as to fix the electronic device on the post.

### BACKGROUND OF THE INVENTION

1. Field of the Invention

The present invention relates to a bracket device, and more particularly, to a bracket device for installing an electronic device on different objects.

2. Description of the Prior Art

With advances of long term evolution (LTE) technology, a mobile communication device, such as a mobile phone, a notebook computer with high speed packet access (HSPA) function and so on has been widely implemented into people's daily life. In general, an antenna device is used for receiving and transmitting wireless signals in a long term evolution network, so that the mobile communication devices are capable of establishing communication in the long term evolution network, so as to transmit data therebetween. Practically, the antenna device needs to be fixed on a fixing object, such as a desk, a wall, a post and so on, for receiving and transmitting the wireless signals.

Conventionally, different bracket devices are used for installing the antenna device onto different fixing objects. However, the above-mentioned different bracket devices cause increase of parts and have different assembly processes. Accordingly, it results in increase of cost, complexity of assembly and thus does not facilitate for mass production. As a result, a bracket device with the reduced amount of part, capability of installing the antenna device on different objects and easy assembly becomes an issue in the industry.

### SUMMARY OF THE INVENTION

The present invention provides a bracket device for installing an electronic device on different objects for solving above drawbacks.

According to an embodiment of the present invention, a bracket device includes a bracket body, a supporting foot, a fixing member and a holding mechanism. The bracket body is combined with the electronic device. The supporting foot is connected to a side of the bracket body for supporting the bracket body and the electronic device. The fixing member is connected to another side of the bracket body, and the fixing member includes at least one hanging structure for hanging the bracket body and the electronic device. The holding mechanism is installed on the fixing member in a detachable manner. The holding mechanism and the fixing member are cooperatively for holding a post, so as to fix the electronic device on the post.

According to another embodiment of the present invention, an abutting structure and two breaches are formed on the fixing member, and the abutting structure is for abutting against a side of the post. The holding mechanism includes a holding member, a bending member and two adjusting nuts. The holding member is for abutting against another side of the post. The bending member is detachably disposed in the two breaches. The bending member, the holding member and the abutting structure on the fixing member cooperatively surround the post, and two thread portions are formed on two end portions of the bending member for being detachably disposed through the holding member. The two adjusting nuts are for respectively screwed on the corresponding thread portion when the two end portions of the bending member are disposed through the holding member, so as to force the holding member, the bending member and the abutting structure of the fixing member to hold the post.

According to another embodiment of the present invention, a plurality of abutting portion is formed on the holding member for abutting against surfaces of the posts with different sizes.

According to another embodiment of the present invention, the bending member is a substantially V-shaped wire structure or a substantially U-shaped wire structure.

According to another embodiment of the present invention, the abutting structure is a substantially V-shaped recess structure or a substantially U-shaped recess structure.

According to another embodiment of the present invention, the at least one hanging structure of the fixing member is a strip hole structure for detachably sheathing a fixing pillar, so that the bracket body and the electronic device are hung on the fixing pillar.

According to another embodiment of the present invention, an assembly hole is formed on an end of the strip hole structure. A positioning hole is formed on the other end of the strip hole structure. A size of the assembly hole is greater than a size of the positioning hole.

According to another embodiment of the present invention, the strip hole structure includes a guiding slot connected to the assembly hole and the positioning hole. The guiding slot is for guiding the fixing pillar from the assembly hole to the positioning hole.

According to another embodiment of the present invention, the bracket device further includes at least one screw component for fixing the bracket body onto the electronic device.

According to another embodiment of the present invention, an assembly opening is formed on the fixing member, and an assembly member passes through the assembly opening for screwing the at least one screw component.

According to another embodiment of the present invention, a routing structure is formed on a side of the supporting foot for containing a signal transmission cable of the electronic device.

According to another embodiment of the present invention, the routing structure is a breach structure or a through hole structure.

According to another embodiment of the present invention, an angle is included between the supporting foot and the bracket body.

According to another embodiment of the present invention, the bracket body, the supporting foot and the fixing member are integrally formed.

According to another embodiment of the present invention, the bracket device further includes a pivotal fixing base. A side of the pivotal fixing base is pivoted to the fixing member. Another side of the pivotal fixing base is for fixing the fixing member, the bracket body and the supporting foot.

According to another embodiment of the present invention, the fixing member includes a first end plate connected to the bracket body and a second end plate, and the pivotal fixing base includes a plate body, a first pivotal plate and a second pivotal plate. The plate body is for fixing the fixing member. The first pivotal plate extends from a side of the plate body for being pivoted to the first end plate. The second pivotal plate extends from another side of the plate body for being pivoted to the second end plate.

According to another embodiment of the present invention, the bracket device further includes a first pivoting member and a second pivoting member. The first pivoting member is for being disposed through the first pivotal plate and the first end plate, so that the first pivotal plate is pivoted to the first end plate. The second pivoting member is for being disposed through the second pivotal plate and the second end plate, so that the second pivotal plate is pivoted to the second end plate.

According to another embodiment of the present invention, the first pivotal plate and the second pivotal plate are respectively a screw component.

According to another embodiment of the present invention, the first pivotal plate and the second pivotal plate are substantially perpendicular to the plate body, respectively.

According to another embodiment of the present invention, the plate body is screwed to the fixing member.

In summary, the bracket device of the present invention utilizes the supporting foot to lean the electronic device against the fixing surface (i.e. the desk), and the bracket device of the present invention further utilizes the hanging structure of the fixing member to hang the electronic device on the other fixing surface (i.e. the wall). In addition, the bracket device of the present invention further utilizes the holding mechanism to hold the electronic device on the post. In other words, the bracket device of the present invention is capable of installing the electronic device on the different objects, such as the desk, the wall, the post and so on. In other words, the bracket device of the present invention is a single one-part structure and can be adapted to different fixing objects. It results in decrease of amount of the parts and simplifies assembly process, so as to facilitate for mass production.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a bracket device and an electronic device in a first fixed status according to an embodiment of the present invention.

FIG. 2 is diagram of the bracket device according to the embodiment of the present invention.

FIG. 3 is a schematic diagram of the bracket device and the electronic device in a second fixed status according to the embodiment of the present invention.

FIG. 4 is an assembly diagram of the bracket device and a fixing pillar according to the embodiment of the present invention.

FIG. 5 is a schematic diagram of the bracket device and the electronic device in a third fixed status according to the embodiment of the present invention.

FIG. 6 is an exploded diagram of the bracket device and the electronic device according to the embodiment of the present invention.

FIG. 7 is a sectional diagram illustrating that a holding mechanism holds a post according to the embodiment of the present invention.

FIG. 8 is a diagram of the holding mechanism according to the embodiment of the present invention.

FIG. 9 to FIG. 12 are diagrams of the electronic device and the holding mechanism in different assembled statuses according to the embodiment of the present invention.

FIG. 13 is a sectional diagram illustrating that the holding mechanism holds another post according to the embodiment of the present invention.

FIG. 14 is a schematic diagram of a bracket device and the electronic device according to another embodiment of the present invention.

FIG. 15 is an exploded diagram of the bracket device and the electronic device according to the other embodiment of the present invention.

### DETAILED DESCRIPTION

In the following detailed description of the embodiments, reference is made to the accompanying drawings which form a part hereof, and in which is shown by way of illustration specific embodiments in which the invention maybe practiced. In this regard, directional terminology, such as “top,” “bottom,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments maybe utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “installed” and variations thereof herein are used broadly and encompass direct and indirect connections and installations. Accordingly, the drawings and descriptions will be regarded as illustrative in nature and not as restrictive.

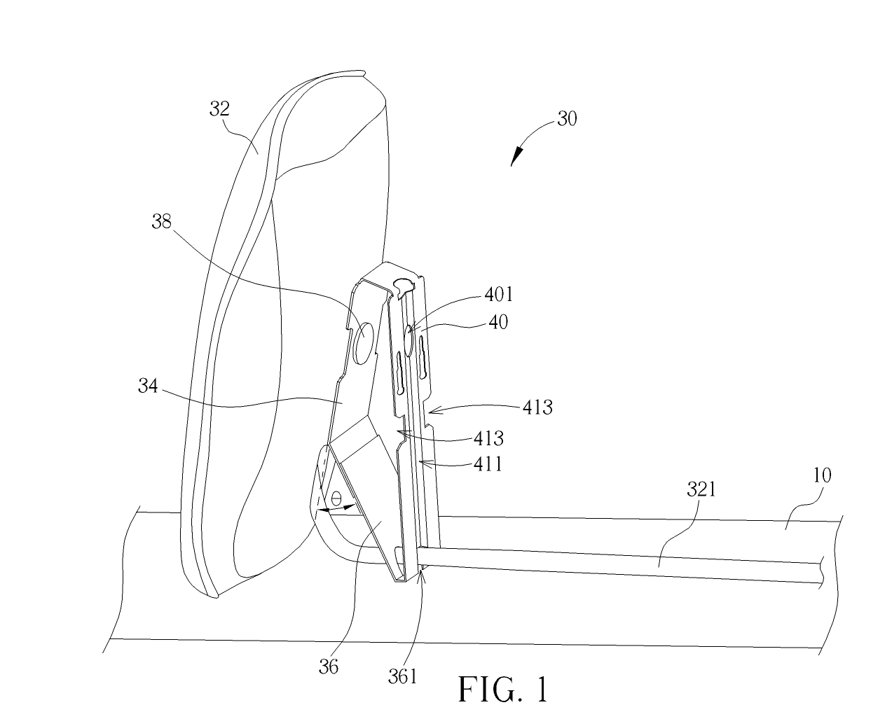

Please refer to FIG. 1. FIG. 1 is a schematic diagram of a bracket device 30 and an electronic device 32 in a first fixed status according to an embodiment of the present invention. As shown in FIG. 1, the bracket device 30 is installed on the electronic device 32, and the bracket device 30 includes a bracket body 34 and a supporting foot 36. The bracket body 34 is used for combining with the electronic device 32, and the supporting foot 36 is connected to a side of the bracket body 34. As shown in FIG. 1, when the bracket body 34 is combined with the electronic device 32, the supporting foot 36 of the bracket device 30 is used for leaning against a fixing surface 10, such as a desk, so as to support the bracket body 34 and the electronic device 32. In other words, the present invention utilizes the supporting foot 36 of the bracket device 30 to support the electronic device 32 on the fixing surface 10.

Furthermore, an angle 8 is included between the supporting foot 36 and the bracket body 34 of the bracket device 30. Since the bracket body 34 is combined with the electronic device 32 in an attached manner, the bracket body 34 after being combined with the electronic device 32 is parallel to the electronic device 32. When the electronic device 32 utilizes the supporting foot 36 of the bracket device 30 for leaning on the fixing surface 10, there is an angle included between the electronic device 32 and the fixing surface 10. In this embodiment, the electronic device 32 is an antenna device, i.e. the bracket device 30 is a bracket for fixing the antenna device. Meanwhile, the angle included between the electronic device 32 and the fixing surface 10 is a lifting angle of the antenna device. It should be noticed that implementations of the bracket device 30 are not limited to those mentioned in this embodiment. For example, the electronic device 32 can be a liquid crystal television as well, and accordingly the bracket device 30 can be a bracket for fixing the liquid crystal television. Meanwhile, the angle included between the electronic device 32 and the fixing surface 10 can be an oriented angle of the liquid crystal television, which provides a user with a comfortable orientation. As for which one of the above-mentioned designs is adopted, it depends on practical demands.

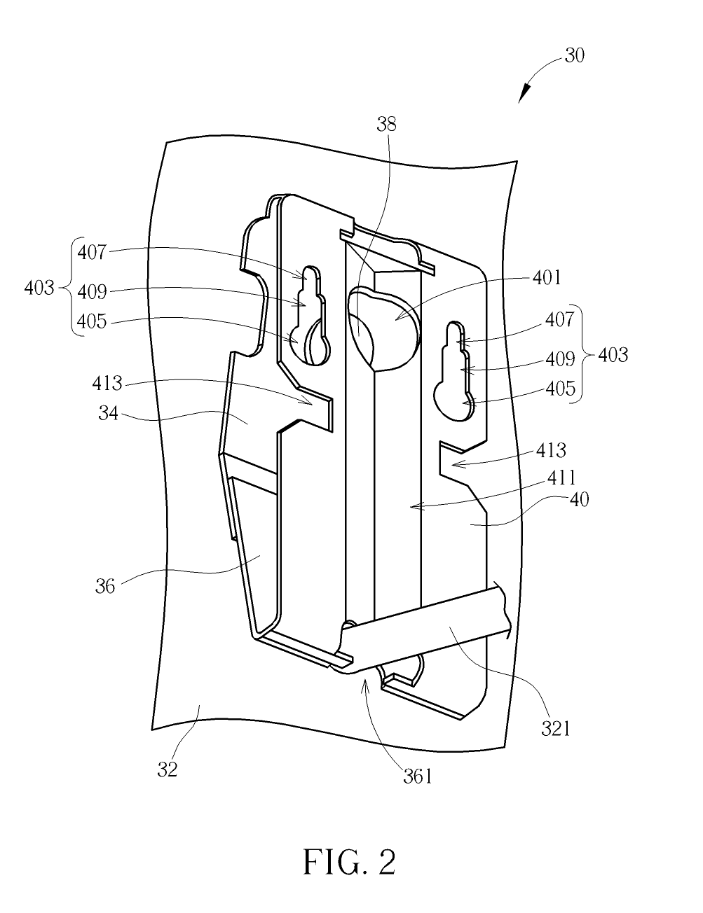

Please refer to FIG. 1 and FIG. 2. FIG. 2 is diagram of the bracket device 30 according to the embodiment of the present invention. As shown in FIG. 1 and FIG. 2, a routing structure 361 is formed on a side of the supporting foot 36 of the bracket device 30. The routing structure 361 on the supporting foot 36 is used for containing a signal transmission cable 321 of the electronic device 32. Practically, the signal transmission cable 321 of the electronic device 32 is connected to a host device (not shown in figures), so that the electronic device and the host device are capable of transmitting signals therebetween. In this embodiment, the routing structure 361 is, but not limited to, a breach structure. For example, the routing structure 361 can be a through hole structure as well. As for which one of the above-mentioned designs is adopted, it depends on practical demands.

Furthermore, the bracket device 30 further includes at least one screw component 38 for fixing the bracket body 34 onto the electronic device 32. In this embodiment, the bracket device 30 includes one screw component 38, and an amount of the screw component 38 is not limited to that mentioned in this embodiment. In other words, the bracket device 30 can include two or three screw components 38. As for which one of the above-mentioned designs is adopted, it depends on practical demands. In other words, structures with at least one screw component 38 are within the scope of the present invention. Furthermore, the bracket device 30 further includes a fixing member 40 connected to another side of the bracket body 34 opposite to the supporting foot 36, and an assembly opening 401 is formed on the fixing member 40. When the screw component 38 is desired to screw the bracket body 34 of the bracket device 30 onto the electronic device 32, the assembly opening 401 on the fixing member 40 provides a panel for the user to utilize an assembly member, such as a screw driver, for screwing the screw component 38 via the assembly opening 401, so as to fix the bracket body 34 onto the electronic device 32.

In this embodiment, the bracket body 34, the supporting foot 36 and the fixing member 40 of the bracket device 30 are integrally formed, i.e. the bracket device 30 is a single one-part structure. Practically, the bracket body 34, the supporting foot 36 and the fixing member 40 can be integrally formed in a stamping manner. Structures of the bracket body 34, the supporting foot 36 and the fixing member 40 of the bracket device 30 are not limited to those mentioned in this embodiment. For example, the bracket body 34, the supporting foot 36 and the fixing member 40 can be respectively a separate part, and the above-mentioned separate parts can be practically combined with one another in a welded manner. As for which one of the above-mentioned designs is adopted, it depends on practical demands.

As shown in FIG. 1 and FIG. 2, the fixing member 40 of the bracket device 30 includes at least one hanging structure 403 for hanging the bracket body 34 and the electronic device 32. In this embodiment, the fixing member 40 of the bracket device 30 includes two hanging structures 403, while an amount of the hanging structure 403 is not limited to that illustrated in figures in this embodiment. In other words, the fixing member 40 can include two or three hanging structures 403, and it depends on practical demands. In other words, structures with at least one hanging structure 403 are within the scope of the present invention. In this embodiment, the hanging structure 403 is a strip hole structure.

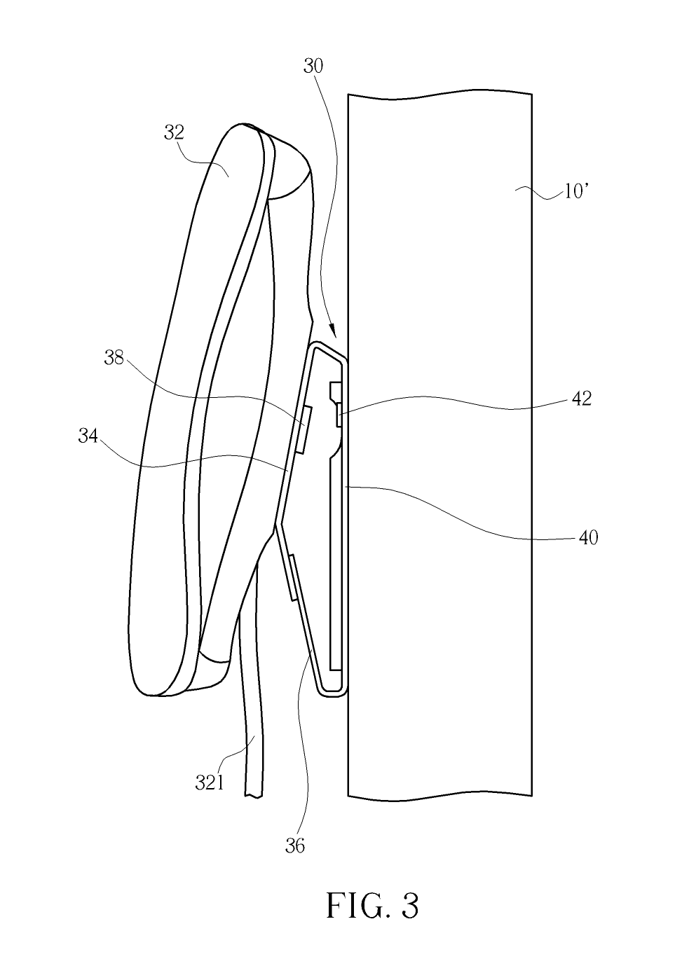

Please refer to FIG. 2 and FIG. 3. FIG. 3 is a schematic diagram of the bracket device 30 and the electronic device 32 in a second fixed status according to the embodiment of the present invention. As shown in FIG. 2 and FIG. 3, when the bracket device 30 and the electronic device 32 are desired to be hung on another fixing surface 10′, such as a wall, the hanging structure 403 (i.e. the strip hole structure) of the fixing member 40 sheathes a fixing pillar 42 on the another fixing surface 10′, so that the fixing member 40 hangs the bracket body 34 and the electronic device 32 on the fixing pillar 42. In other words, the bracket device 30 of the present invention utilizes the hanging structure 403 of the fixing member 40 to sheathe the fixing pillar 42 on the another fixing surface 10′, so as to hang the electronic device 32 combined with the bracket body 34 on the another fixing surface 10′ (i.e. the wall).

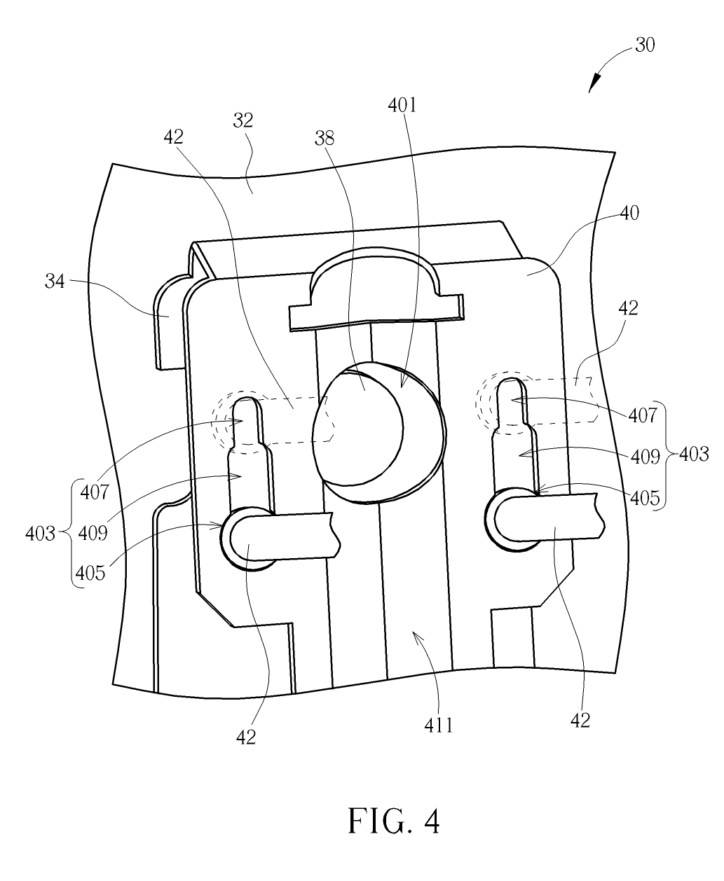

In this embodiment, the fixing pillar 42 is a screw component. As shown in FIG. 2, an assembly hole 405 is formed on an end of the strip hole structure (i.e. the hanging structure 403), and a positioning hole 407 is formed on the other end of the strip hole structure. Please refer to FIG. 2 to FIG. 4. FIG. 4 is an assembly diagram of the bracket device 30 and the fixing pillar 42 according to the embodiment of the present invention. As shown in FIG. 2 to FIG. 4, when the hanging structure 403 is desired to sheathe the fixing pillar 42 on the fixing surface 10′, the fixing pillar 42 (i.e. the screw component) is pushed along the strip hole structure (i.e. the hanging structure 403) after the end of the fixing pillar 42 is disposed through the assembly hole 405, until the fixing pillar 42 moves from a position illustrated in solid line to a position illustrated in dashed line, as shown in FIG. 4. Meanwhile, the positioning hole 407 of the strip hole structure (i.e. the hanging structure 403) engages with the fixing pillar 42, so as to fix the fixing member 40 with the fixing pillar 42. In such a manner, the electronic device 32 combined with the bracket body 34 is capable of stably hanging on the fixing surface 10′ (i.e. the wall). Structures of the fixing pillar 42 are not limited to those illustrated in figures in this embodiment. For example, the fixing pillar 42 can be a nail as well. As for which one of the above-mentioned designs is adopted, it depends on practical demands.

In this embodiment, the strip hole structure (i.e. the hanging structure 403) comprises a guiding slot 409 connected to the assembly hole 405 and the positioning hole 407. During the fixing pillar 42 is pushed along the strip hole structure (i.e. the hanging structure 403), the guiding slot 409 is used for guiding the fixing pillar 42 from the assembly hole 405 to the positioning hole 407. In other words, the guiding slot 409 is used for guiding the fixing pillar 42 from the position illustrated in solid line to the position illustrated in dashed line, as shown in FIG. 4, so that the fixing pillar 42 smoothly slides from the assembly hole 405 to the positioning hole 407. It should be noticed that the guiding slot 409 of the strip hole structure can be omitted, i.e. the present invention can omit the guiding slot 409 for saving manufacture costs of the strip hole (i.e. the hanging structure 403).

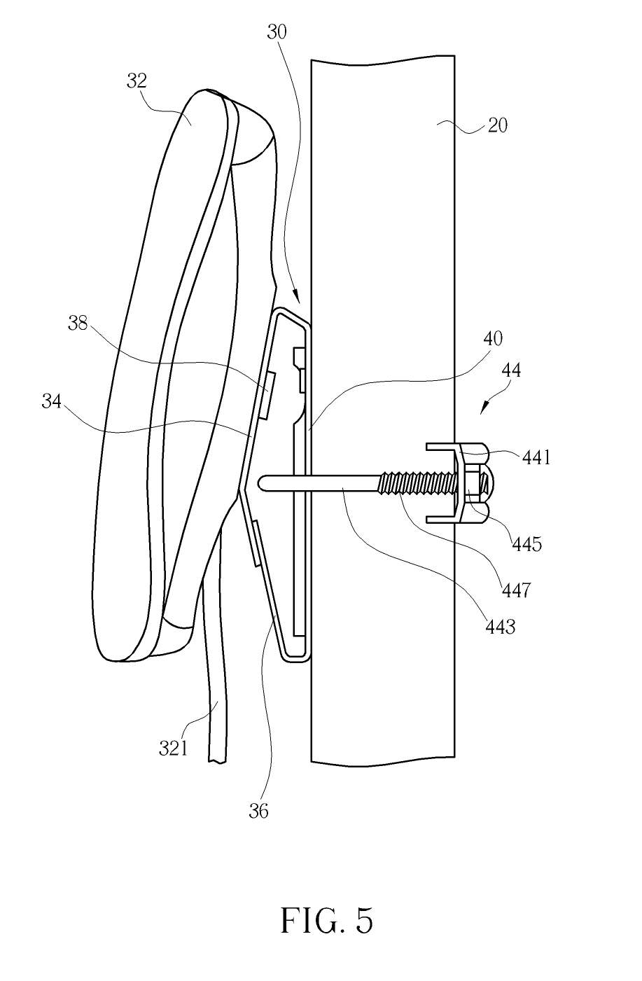

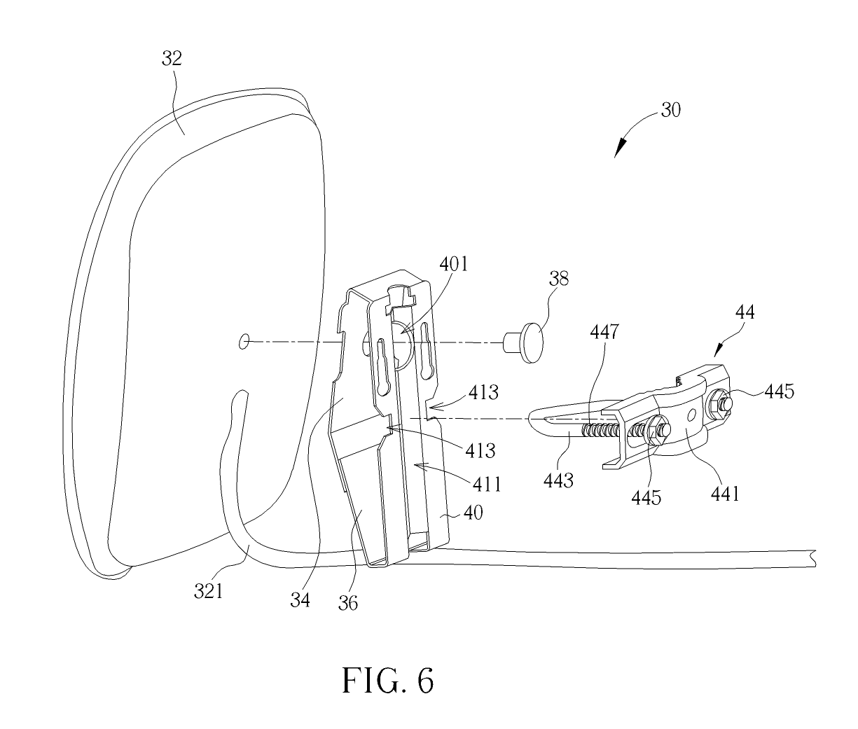

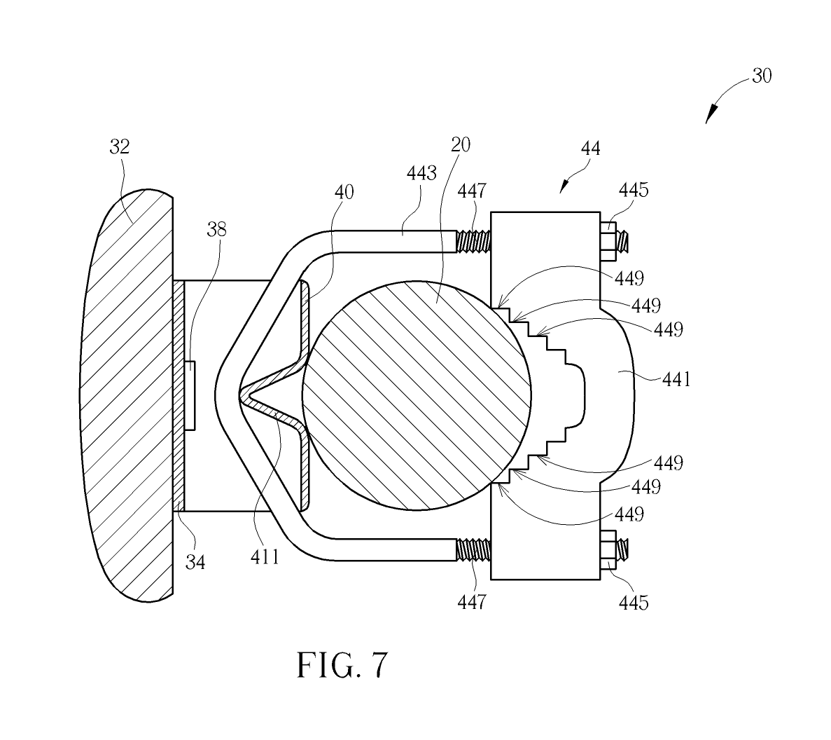

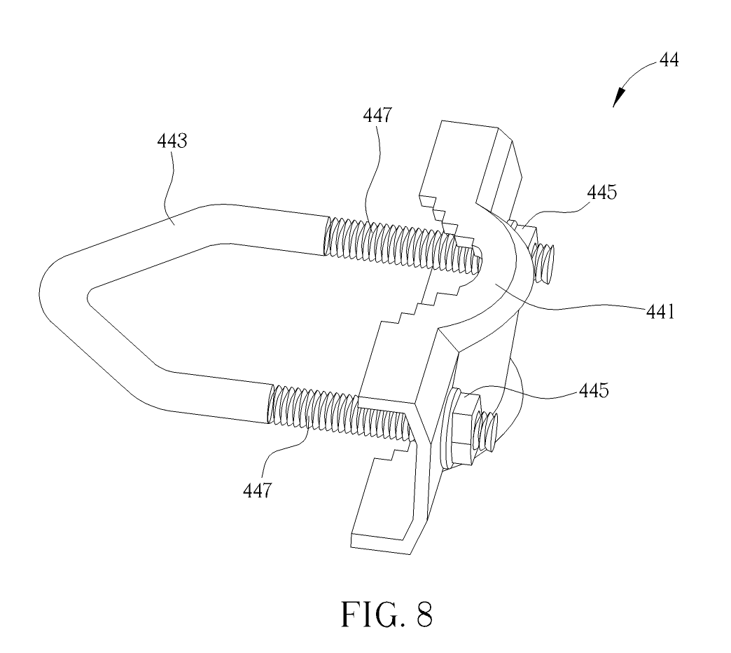

Please refer to FIG. 5. FIG. 5 is a schematic diagram of the bracket device 30 and the electronic device 32 in a third fixed status according to the embodiment of the present invention. As shown in FIG. 5, the bracket device 30 further includes a holding mechanism 44 installed on the fixing member 40 of the bracket device 30 in a detachable manner. The holding mechanism 44 and the fixing member 40 are cooperatively used for holding a post 20, so as to fix the electronic device 32 on the post 20. Please refer to FIG. 5 to FIG. 8. FIG. 6 is an exploded diagram of the bracket device 30 and the electronic device 32 according to the embodiment of the present invention. FIG. 7 is a sectional diagram illustrating that the holding mechanism 44 holds the post 20 according to the embodiment of the present invention. FIG. 8 is a diagram of the holding mechanism 44 according to the embodiment of the present invention. As shown in FIG. 5 to FIG. 8, an abutting structure 411 and two breaches 413 are formed on the fixing member 40 of the bracket device 30, and the abutting structure 411 is used for abutting a side of the post 20, as shown in FIG. 7.

In this embodiment, the abutting structure 411 of the fixing member 40 is a substantially V-shaped recess structure. When the abutting structure 411 abuts against the side of the post 20, the substantially V-shaped structure (i.e. the abutting structure 411) is used for increasing a contact surface which the abutting structure 411 abuts against the post 20, so that the abutting structure 411 abuts against the post 20 more stably. Structures of the abutting structure 411 of the fixing member 40 are not limited to those illustrated in the figures in this embodiment. For example, the abutting structure 411 of the fixing member 40 can be a substantially U-shaped recess structure as well. As for which one of the above-mentioned designs is adopted, it depends on practical demands.

Furthermore, the holding mechanism 44 includes a holding member 441, a bending member 443 and two adjusting nuts 445. The abutting structure 411 is used for abutting against another side of the post 20, as shown in FIG. 7. The bending member 443 is detachably disposed in the two breaches 413 on the fixing member 40. Two thread portions 447 are formed on two end portions of the bending member 443 for being detachably disposed through the holding member 441. When the two end portions of the bending member 443 are disposed through the holding member 441, the two adjusting nuts 445 are respectively used for screwing the corresponding thread portion 447.

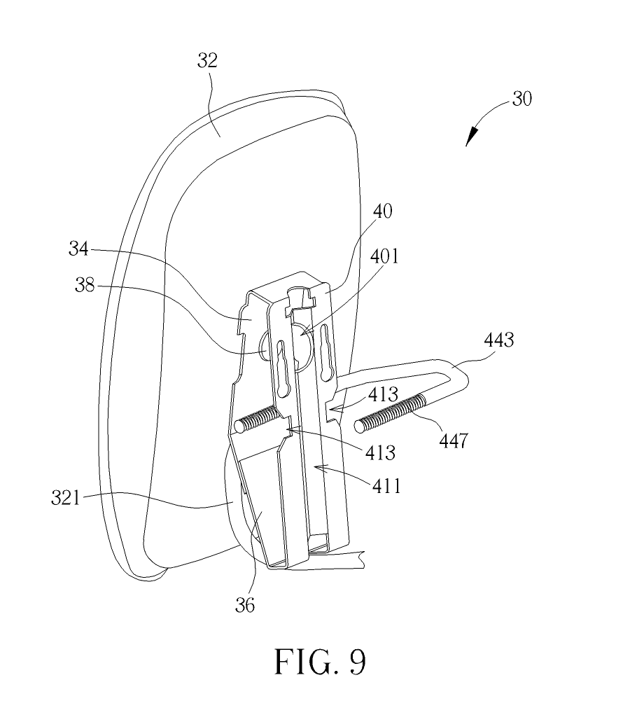

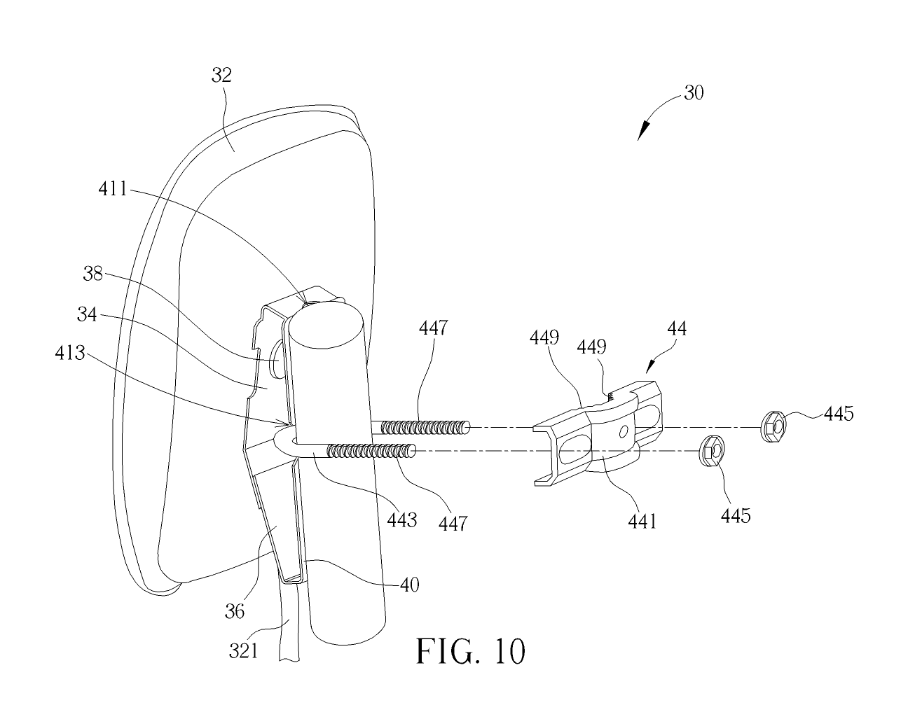

Please refer to FIG. 9 to FIG. 12. FIG. 9 to FIG. 12 are diagrams of the electronic device 32 and the holding mechanism 44 indifferent assembled statuses according to the embodiment of the present invention. As shown in FIG. 9 to FIG. 12, when the electronic device 32 is desired to be fixed on the post 20, the bending member 443 of the holding mechanism 44 first surrounds the fixing member 40, as shown in FIG. 9, and two sides of the bending member 443 are disposed in the two breaches 413 on the fixing member 40. Afterwards, the bending member 443 with the fixing member 40 abut against the side of the post 20, so that the abutting structure 411 of the fixing member 40 abuts against the side of the post 20, as shown in FIG. 10.

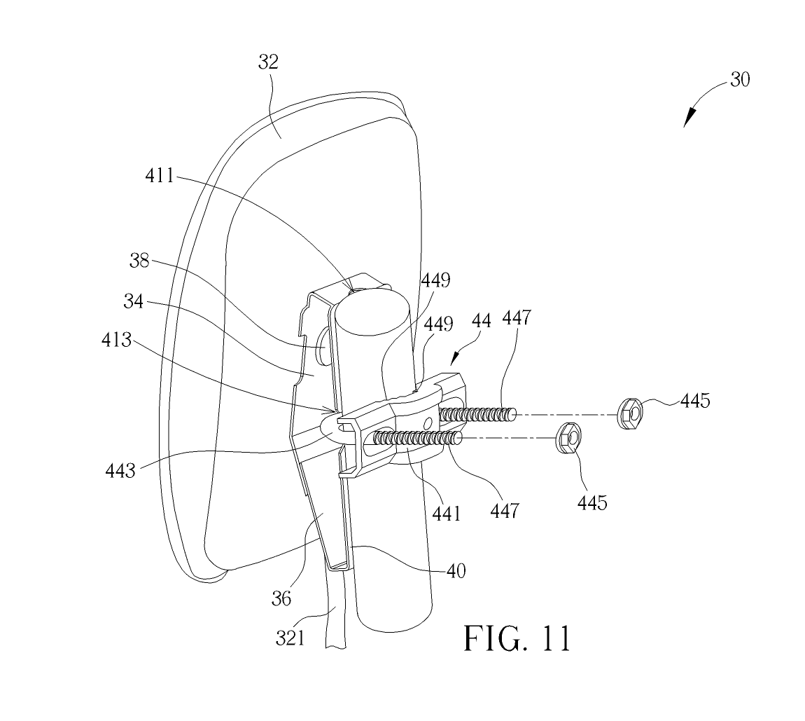

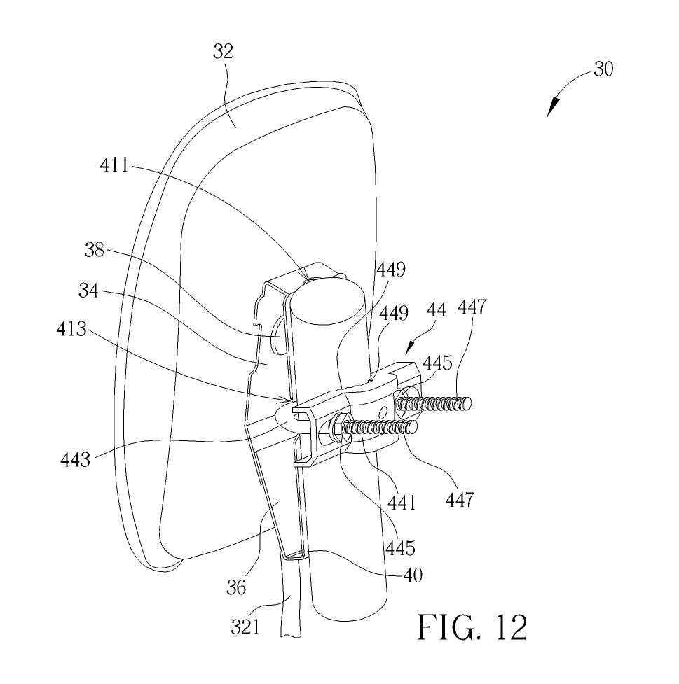

Then, the two end portions of the bending member 443 are disposed through the holding member 441, so that the bending member 443, the holding member 441 and the abutting structure 411 on the fixing member 40 cooperatively surround the post 20, as shown in FIG. 11. Finally, the two adjusting nuts 445 are respectively screwed on the corresponding thread portions 447 on the two end portions of the bending member 443, as shown in FIG. 12, so as to force the abutting structure 411, the bending member 443 and the abutting structure 411 on the fixing member 40 to hold the post 20. In such a manner, the holding mechanism 44 of the bracket device 30 can fix the electronic device 32 on the post 20.

In this embodiment, the bending member 443 of the holding mechanism 44 is a substantially V-shaped wire structure, and two sides of the substantially V-shaped wire structure (i.e. the bending member 443) are detachably disposed in the two breaches 413 on the fixing member 40. Structures of the bending member 443 of the fixing member 40 are not limited to those illustrated in the figures in this embodiment. For example, the bending member 443 of the holding mechanism 44 can be a substantially U-shaped wire structure as well. As for which one of the above-mentioned designs is adopted, it depends on practical demands.

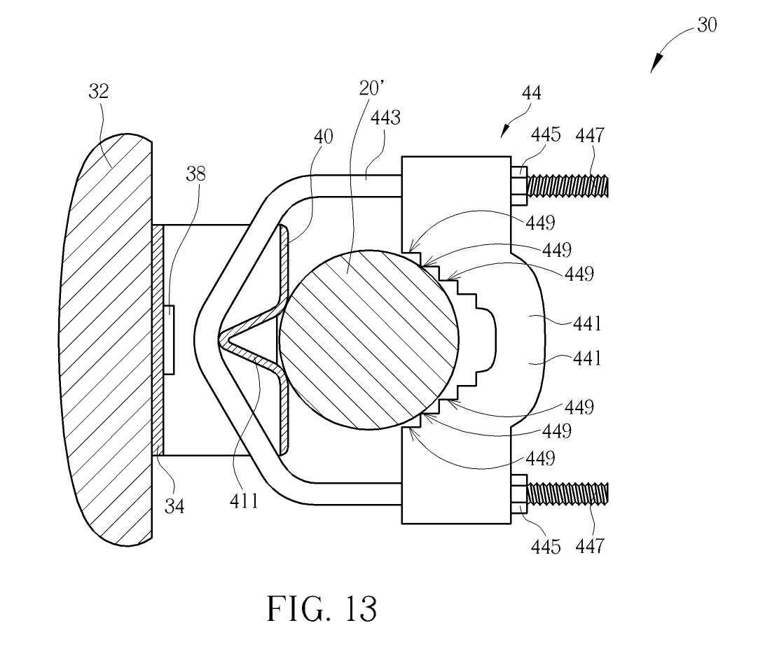

Please refer to FIG. 7 and FIG. 13. FIG. 13 is a sectional diagram illustrating that the holding mechanism 44 holds another post 20′ according to the embodiment of the present invention. As shown in FIG. 7 and FIG. 13, a plurality of abutting portions 449 is formed on the holding member 441 of the holding mechanism 44. As shown in FIG. 7, one of the plurality of abutting portions 449 on the holding member 441 is used for abutting against the other side of the post 20, so that the holding member 441, the bending member 443 and the abutting structure 411 on the fixing member 40 hold the post 20. As shown in FIG. 13, another one of the plurality of abutting portions 449 on the holding member 441 is used for abutting against another side of the post 20′, so that the holding member 441, the bending member 443 and the abutting structure 411 on the fixing member 40 hold the post 20′.

As mentioned above, a diameter of the post 20′ is smaller than a diameter of the post 20. In other words, the plurality of abutting portions 449 on the holding member 441 are used for abutting against surfaces of posts with different sizes, respectively. Accordingly, the holding mechanism 44 of the present invention is capable of holding the posts with different sizes, so as to increase flexibility of the bracket device 30 in use. An amount of the abutting portion 449 on the holding member 441 is not limited to that illustrated in the figures in this embodiment, and it depends on practical demands.

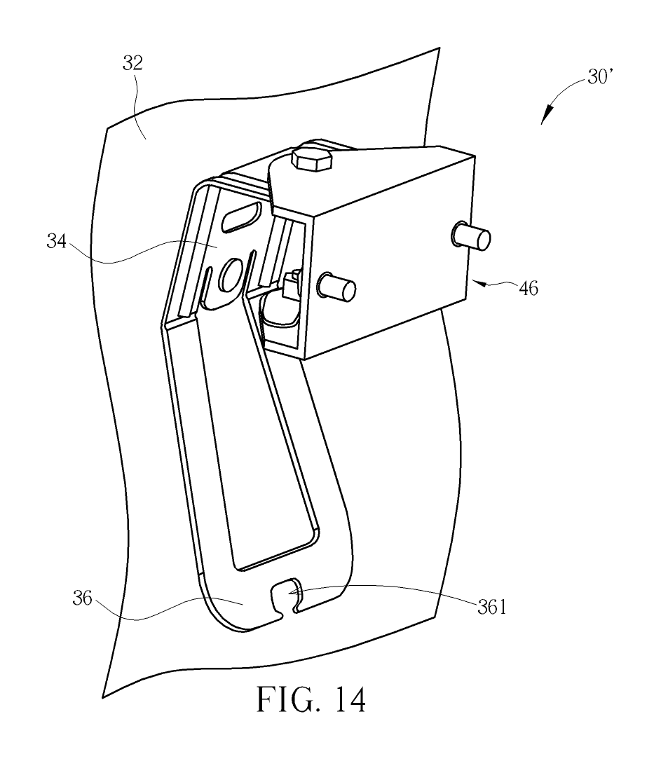

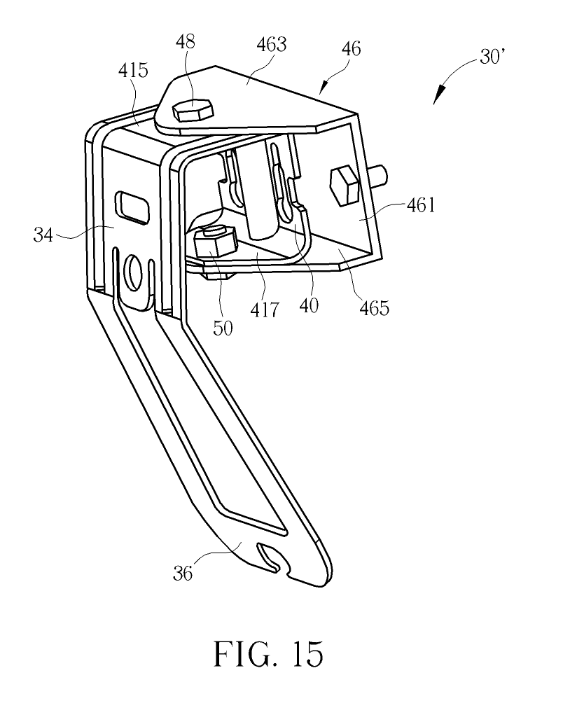

Please refer to FIG. 14 and FIG. 15. FIG. 14 is a schematic diagram of a bracket device 30′ and the electronic device 32 according to another embodiment of the present invention. FIG. 15 is an exploded diagram of the bracket device 30′ and the electronic device 32 according to the other embodiment of the present invention. As shown in FIG. 14 and FIG. 15, the main difference between the bracket device 30′ and the aforesaid bracket device 30 is that the bracket device 30′ further includes a pivotal fixing base 46. A side of the pivotal fixing base 46 is pivoted to the fixing member 40 of the bracket device 30′, and another side of the pivotal fixing base 46 is used for fixing the fixing member 40, the bracket body 34 and the supporting foot 36 of the bracket device 30′ on a wall, i.e. the pivotal fixing base 46 of the bracket device 30′ is a bridge mechanism for bridging the electronic device 32 onto the wall.

Furthermore, the pivotal fixing base 46 includes a plate body 461 for fixing the fixing member 40 onto the wall. In this embodiment, the plate body 461 of the pivotal fixing base 46 fixes, but not limited to, the fixing member 40 onto the wall in a screwing manner. For example, the plate body 461 of the pivotal fixing base 46 can fix the fixing member 40 onto the wall in a reveted manner as well. As for which one of the above-mentioned designs is adopted, it depends on practical demands. In addition, the fixing member 40 of the bracket device 30′ includes a first end plate 415 connected to the bracket body 34 and a second end plate 417. The pivotal fixing base 46 further includes a first pivotal plate 463 and a second pivotal plate 465. The first pivotal plate 463 extends from a side of the plate body 461, and the second pivotal plate 465 extends from another side of the plate body 461. In this embodiment, the first pivotal plate 463 and the second pivotal plate 465 are substantially perpendicular to the plate body 461, respectively. In other words, the pivotal fixing base 46 is a substantially U-shaped structure.

Furthermore, the bracket device 30′ further includes a first pivoting member 48 and a second pivoting member 50. The first pivoting member 48 is used for being disposed through the first pivotal plate 463 and the first end plate 415, so that the first pivotal plate 463 is pivoted to the first end plate 415. The second pivoting member 50 is used for being disposed through the second pivotal plate 465 and the second end plate 417, so that the second pivotal plate 465 is pivoted to the second end plate 417. Accordingly, the pivotal fixing base 46 can be pivoted to the fixing member 40 of the bracket device 30′. In this embodiment, the first pivoting member 48 and the second pivoting member 50 are respectively a screw component. In summary, the pivotal fixing base 46 of the bracket device 30′ utilizes the plate body 461 to fix the electronic device 32 onto the wall, and the pivotal fixing base 46 further utilizes the first pivoting member 48 and the second pivoting member 50 to be pivoted to the fixing member 40, so that the electronic device 32 is capable of rotating relative to the wall. In other words, the bracket device 30′ can not only fix the electronic device 32 onto the wall but also rotate the electronic device 32 relative to the wall, so as to increase flexibility of the electronic device 32 in use.

Compared to the prior art, the bracket device of the present invention utilizes the supporting foot to lean the electronic device against the fixing surface (i.e. the desk), and the bracket device of the present invention further utilizes the hanging structure of the fixing member to hang the electronic device on the other fixing surface (i.e. the wall). In addition, the bracket device of the present invention further utilizes the holding mechanism to hold the electronic device on the post. In other words, the bracket device of the present invention is capable of installing the electronic device on the different objects, such as the desk, the wall, the post and so on. In other words, the bracket device of the present invention is a single one-part structure and can be adapted to different fixing objects. It results in decrease of amount of the parts and simplifies assembly process, so as to facilitate for mass production.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A bracket device for installing an electronic device on different objects, comprising:
a bracket body for combining with the electronic device;
a supporting foot connected to a side of the bracket body for supporting the bracket body and the electronic device;
a fixing member connected to another side of the bracket body, the fixing member comprising at least one hanging structure for hanging the bracket body and the electronic device; and
a holding mechanism installed on the fixing member in a detachable manner, the holding mechanism and the fixing member being cooperatively for holding a post, so as to fix the electronic device on the post.

2. The bracket device of claim 1, wherein an abutting structure and two breaches are formed on the fixing member, the abutting structure is for abutting against a side of the post, and the holding mechanism comprises:
a holding member for abutting against another side of the post;
a bending member detachably disposed in the two breaches, the bending member, the holding member and the abutting structure on the fixing member cooperatively surrounding the post, two thread portions being formed on two end portions of the bending member for being detachably disposed through the holding member; and
two adjusting nuts for being respectively screwed on the corresponding thread portion when the two end portions of the bending member are disposed through the holding member, so as to force the holding member, the bending member and the abutting structure of the fixing member to hold the post.

3. The bracket device of claim 2, wherein a plurality of abutting portion is formed on the holding member for abutting against surfaces of the posts with different sizes.

4. The bracket device of claim 2, wherein the bending member is a substantially V-shaped wire structure or a substantially U-shaped wire structure.

5. The bracket device of claim 2, wherein the abutting structure is a substantially V-shaped recess structure or a substantially U-shaped recess structure.

6. The bracket device of claim 1, wherein the at least one hanging structure of the fixing member is a strip hole structure for detachably sheathing a fixing pillar, so that the bracket body and the electronic device are hung on the fixing pillar.

7. The bracket device of claim 6, wherein an assembly hole is formed on an end of the strip hole structure, a positioning hole is formed on the other end of the strip hole structure, and a size of the assembly hole is greater than a size of the positioning hole.

8. The bracket device of claim 7, wherein the strip hole structure comprises a guiding slot connected to the assembly hole and the positioning hole, the guiding slot is for guiding the fixing pillar from the assembly hole to the positioning hole.

9. The bracket device of claim 1, further comprising at least one screw component for fixing the bracket body onto the electronic device.

10. The bracket device of claim 9, wherein an assembly opening is formed on the fixing member, and an assembly member passes through the assembly opening for screwing the at least one screw component.

11. The bracket device of claim 1, wherein a routing structure is formed on a side of the supporting foot for containing a signal transmission cable of the electronic device.

12. The bracket device of claim 11, wherein the routing structure is a breach structure or a through hole structure.

13. The bracket device of claim 1, wherein an angle is included between the supporting foot and the bracket body.

14. The bracket device of claim 1, wherein the bracket body, the supporting foot and the fixing member are integrally formed.

15. The bracket device of claim 1, further comprising:
a pivotal fixing base, a side of the pivotal fixing base being pivoted to the fixing member, another side of the pivotal fixing base being for fixing the fixing member, the bracket body and the supporting foot.

16. The bracket device of claim 15, wherein the fixing member comprises a first end plate connected to the bracket body and a second end plate, and the pivotal fixing base comprises:
a plate body for fixing the fixing member;
a first pivotal plate extending from a side of the plate body for being pivoted to the first end plate; and
a second pivotal plate extending from another side of the plate body for being pivoted to the second end plate.

17. The bracket device of claim 16, further comprising:
a first pivoting member for being disposed through the first pivotal plate and the first end plate, so that the first pivotal plate is pivoted to the first end plate; and
a second pivoting member for being disposed through the second pivotal plate and the second end plate, so that the second pivotal plate is pivoted to the second end plate.

18. The bracket device of claim 17, wherein the first pivotal plate and the second pivotal plate are respectively a screw component.

19. The bracket device of claim 16, wherein the first pivotal plate and the second pivotal plate are substantially perpendicular to the plate body, respectively.

20. The bracket device of claim 16, wherein the plate body is screwed to the fixing member.
